(19) United States
(12) Patent Application Publication
(10) Pub. No.: US 2003/0083111 A1
(43) Pub. Date: May 1, 2003

(54) Compact mobile phone device with hook

(76) Inventor: Clark Wu, Taipei (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 09/984,106

(22) Filed: Oct. 29, 2001

(51) Int. Cl. H04M 1/00

(52) U.S. Cl. 455/568; 455/569; 455/564

(57) ABSTRACT

A compact mobile phone device includes a dial control module for attaching to a user's waist belt and a voice module for wearing on the user's one ear. The dial control module includes a function keypad and a radio transmission module. The voice module includes a high-frequency signal processing circuit, a voice processing circuit, a sounding unit, a voice-receiving unit, and a radio receiver module. The high-frequency signal processing circuit establishes a communication link, and the voice processing circuit enables the user to talk with a remote user via the established communication link. The dial control module and the voice module may also be integrated in a single compact mobile phone device.

### BACKGROUND OF THE INVENTION

1. Field of the Invention

The present invention relates to a mobile communication device, and more particularly to a compact mobile phone device with hook for wearing on a user's one ear.

2. Description of the Prior Art

Mobile phones have become a prerequisite communication device in nowadays industrial and commercial society. With the highly advanced communication and data transmission techniques, a mobile phone provides not only general communication functions but also many other additional functions, such as transmission of real-time stock information, transmission of traffic information, transmission of short messages, and transmission of various kinds of data.

Under this condition, people in different trades rely on the mobile phones much more than before and carry the mobile phones with them almost at any time. Various attaching means for mobile phones, such as mobile phone covers, clips, etc., have been developed to enable convenient carrying of mobile phones with users.

There are also various types of wireless earpieces developed for mobile phones, so that vocal signals received with a mobile phone may be sent to a user's ear via transmission module and receiving module by way of infrared or radio transmission. Such type of mobile phone having earpiece is convenient for use, but the user has to mount transmission and receiving modules on both the mobile phone and the earpiece, resulting in another form of inconvenience in using the mobile phone. Thus, it would be more convenient to users if the mobile phone were integrated into a compact device with hook for wearing on the user's ear. With the largely improved mobile communication techniques, it is possible to form most control components inside the mobile phone into an integrated unit to largely reduce the volume of the mobile phone developed in early stage. Thus, a compact mobile phone having small volume for wearing on ear would doubtlessly be widely welcomed and become very popular among consumers.

On the other hand, even if the mobile phone could currently be manufactured to provide various kinds of powerful functions, there are many occasions, such as traveling overseas, in which the user might need only a mobile phone that provides some basic and simplest functions, such as receiving incoming calls, and therefore could be supplied at reduced price. Traditional mobile phones, that are designed to provide several decades or hundreds of complicate functions, apparently could not meet this requirement. Therefore, it is practical to produce a communication device that provides only some simple and most frequently used functions as another choice for consumers.

### SUMMARY OF THE INVENTION

A primary object of the present invention is to provide a compact mobile phone device with hook that includes a dial control module for attaching to, for example, a user's waist belt for entering phone numbers and controlling commands, and a separate voice module having a hook for directly wearing on a user's one ear for the user to listen to an incoming call and to talk with a caller without the need of holding the mobile phone.

Another object of the present invention is to provide a compact mobile phone device with hook that provides only some basic and simplified communication functions, such as receiving incoming calls, so that the user could use the compact mobile phone to perform some simple mobile communication functions.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 is a perspective view of a compact mobile phone device with hook according to a first embodiment of the present invention;

FIG. 2 is an exploded perspective view of a voice module included in the compact mobile phone device of FIG. 1;

FIG. 3 is a functional circuit block diagram of a dial control module included in the compact mobile phone device of FIG. 1;

FIG. 4 is a functional circuit block diagram of a voice module included in the compact mobile phone device of FIG. 1;

FIG. 5 is a perspective view of a compact mobile phone device according to a second embodiment of the present invention;

FIG. 6 is an exploded perspective view of the compact mobile phone device of FIG. 5; and

FIG. 7 is a functional circuit block diagram of the compact mobile phone device of FIG. 5.

### DETAILED DESCRIPTION OF THE PREFERRED EMBODIMENTS

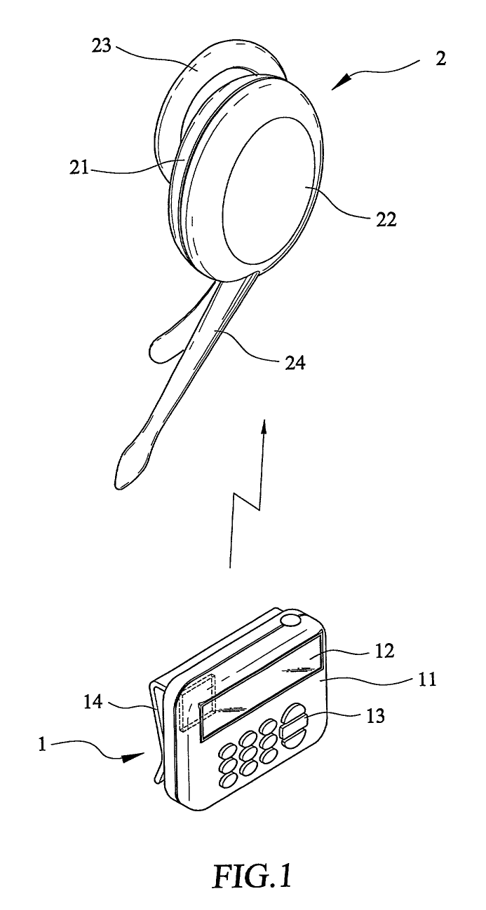

Please refer to FIG. 1 that shows a compact mobile phone device according to a first embodiment of the present invention. As shown, the compact mobile phone device mainly includes a dial control module 1 that may be clipped to, for example, a user's waist belt, and a voice module 2 that is adapted to be hanged on a user's one ear.

As can be seen from FIG. 1, the dial control module 1 includes a casing 11, on which a small-size display unit 12 and a function keypad 13 are provided, and a clip 14 attached to a rear side of the casing 11; and the voice module 2 includes a first casing 21, a second casing 22, a hook-shaped earpiece 23, and an extension bar 24.

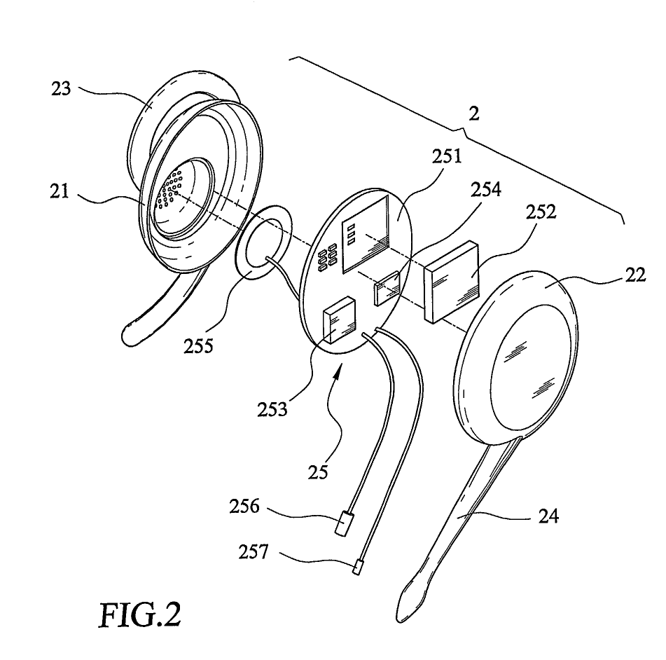

FIG. 2 is an exploded perspective view of the voice module 2. The earpiece 23 is connected to an outer side of the first casing 21 and has a curved hook-like configuration suitable for wearing on the ear. The extension bar 24 is connected to and extended from a lower outer side of the second casing 22, so that the extension bar 24 is extended to a position closely in front of the user's mouth when the earpiece 23 is worn on the ear.

The first and the second casings 21, 22 together define an internal space between them for receiving a mobile phone module 25 therein. The mobile phone module 25 mainly includes a circuit board 251, a battery 252, a control unit 253, and a radio receiver module 254. The control unit 253 is an integrated circuit (IC) component, in which multiple functional circuits required for communication over a mobile phone are integrated through IC techniques.

The mobile phone module 25 further includes a sounding unit 255, a voice-receiving unit 256, and a radio signal receiver 257.

The sounding unit 255 is fitly attached to an inner side of the first casing 21 and connected to the circuit board 251 via a pair of wires. The sounding unit 255 may be a speaker or an earplug type sounder. When the user wears the voice module 2 on one ear, the sounding unit 255 is closely positioned outside the user's ear, allowing the user to clearly listen to incoming vocal signals via the sounding unit 255.

The voice-receiving unit 256 is received in the extension bar 24 near a front end thereof for receiving the user's voice, and is electrically connected to the circuit board 251 via a second wire, so that vocal signals of the user's voice is sent to the mobile phone module 25 via the second wire.

The radio signal receiver 257 is also received in the extension bar 24 near the front end thereof for receiving control signals transmitted from the dial control module 1, and is electrically connected to the circuit board 251 via a third wire, so as to send the control signals received from the dial control module 1 to the mobile phone module 25 via the third wire.

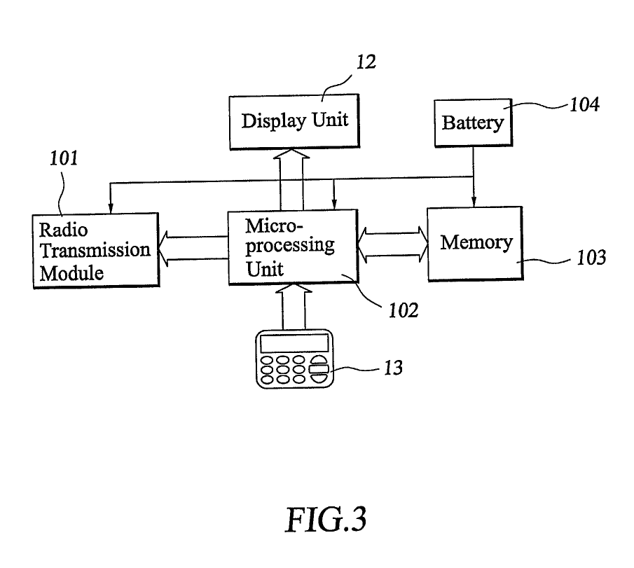

FIG. 3 is a functional circuit block diagram of the dial control module 1 of the present invention. According to FIG. 3, the dial control module 1 includes a radio transmission module 101, a micro-processing unit 102, a memory 103, and a battery 104. The user may enter a phone number and run operational functions on the mobile phone by pushing keys in the function keypad 13 on the casing 11 of the dial control module 1. By employing radio transmission techniques, such as infrared or radio frequency signal transmission, commands and phone numbers entered via the function keypad 13 could be sent via the radio transmission module 101 to the voice module 2 being worn on the ear.

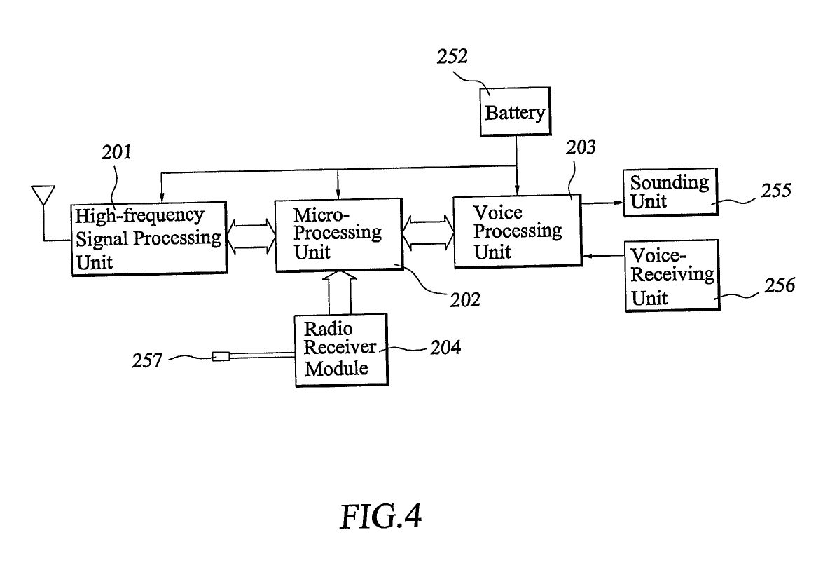

FIG. 4 is a functional circuit block diagram of the voice module 2 of the present invention. According to FIG. 4, the voice module 2 includes a high-frequency signal processing circuit 201, a micro-processing unit 202, a voice processing circuit 203, and a radio receiver module 204. The high-frequency signal processing circuit 201 of the compact mobile phone device of the present invention enables the user to establish a communication link with a vicinal base station included in an available mobile phone communication network, and to talk with a remote user through the linked base station via the voice processing circuit 203. The voice processing circuit 203 is electrically connected to the sounding unit 255 and the voice-receiving unit 256. The battery 252 supplies power needed for the voice module 2 to work.

The radio receiver module 204 enables receiving of signals transmitted from the radio transmission module 101 of the dial control module 1 via the radio signal receiver 257 and sending of the received signal to the micro-processing unit 202.

To use the present invention, the user may attach the clip 14 of the dial control module 1 to a waist belt or any other area allowing convenient access of the dial control module 1, and wears the hook-shaped earpiece 23 of the voice module 2 on one ear. When there is an incoming call, the user may talk with the caller directly over the voice module 2. And, when the user wants to make a call, he or she may push keys in the functional key 13 on the casing 11 of the dial control module 1 to enter a desired phone number and execute the dial function. After the call is answered, the user may talk with the receiver directly over the voice module 2 worn on the ear.

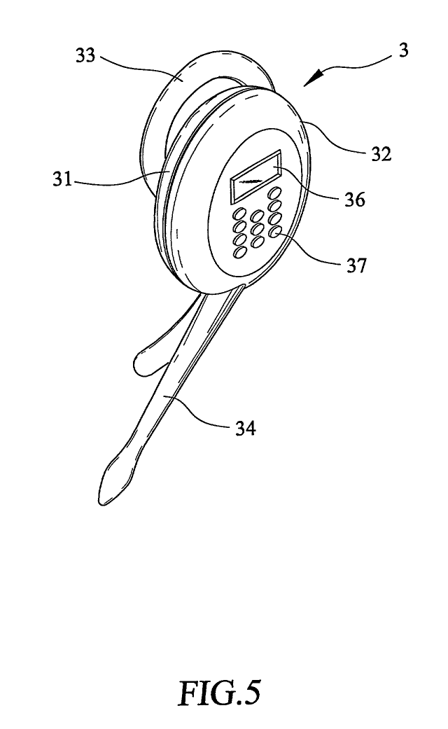

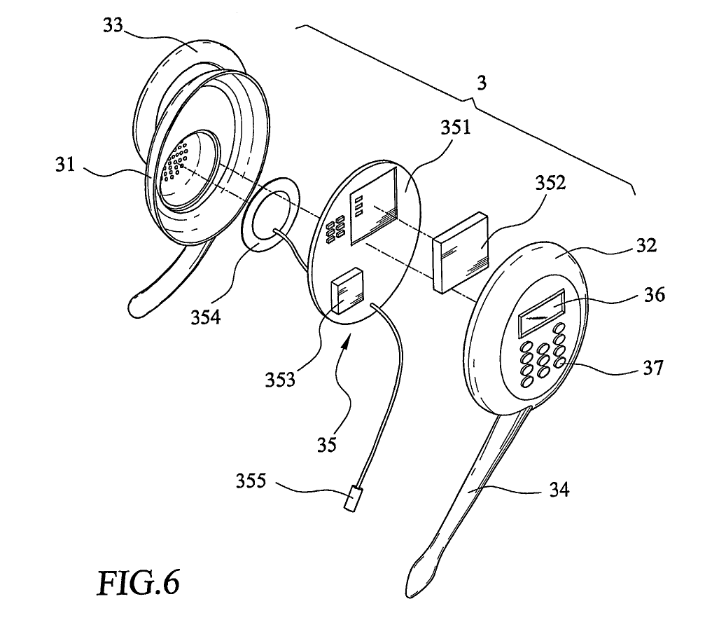

With reference to FIG. 5, it shows a compact mobile phone device according to a second embodiment of the present invention. FIG. 6 is an exploded perspective view of the compact mobile phone device of FIG. 5. As shown, the compact mobile phone device 3 mainly includes a dial control module and a voice module therein, which is suitable to be hanged on a user's one ear.

As can be seen from FIG. 5, the compact mobile phone device 3 includes a first casing 31, a second casing 32, a hook-shaped earpiece 33, an extension bar 34. A mobile phone module 35 is mounted between the first casing 31 and the second casing 32. Further, a display unit 36 and a function keypad 37 is mounted on the second casing 32.

The mobile phone module 35 includes a circuit board 351, a battery 352, and a control unit 353. A sounding unit 354 is attached to an inner side of the first casing 31 and electrically connected to the circuit board 351 via a pair of wires.

A voice-receiving unit 355 is received in the extension bar 34 near a front end thereof for receiving the user's voice, and is electrically connected to the circuit board 351 via a pair of wires, so that vocal signals of the user's voice is sent to the control unit 353 of the mobile phone module 35.

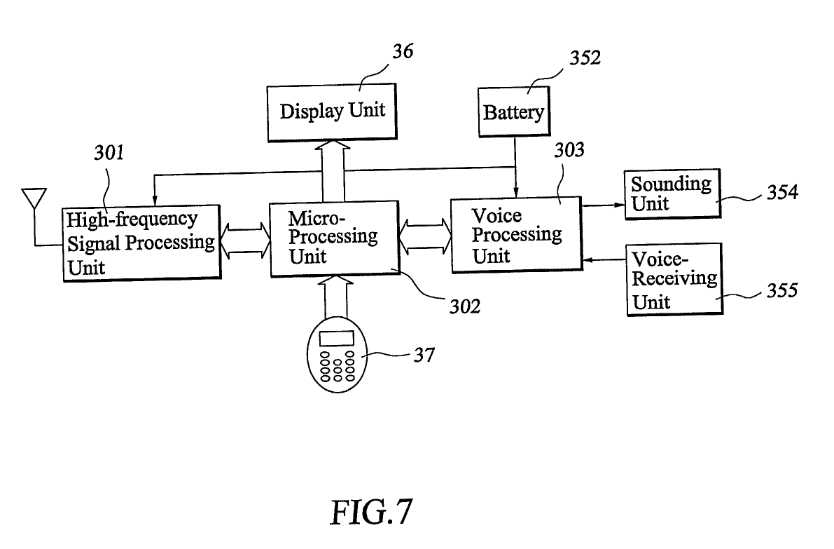

FIG. 7 is a functional circuit block diagram of the compact mobile phone device of FIG. 5. According to FIG. 7, the compact mobile phone device of the present invention mainly includes a high-frequency signal processing circuit 301, a micro-processing unit 302, and a voice processing circuit 303. The high-frequency signal processing circuit 301 of the compact mobile phone device of the present invention enables the user to establish a communication link with a vicinal base station included in an available mobile phone communication network, and to talk with a remote user through the linked base station via the voice processing circuit 303. The voice processing circuit 303 is electrically connected to the sounding unit 354 and the voice-receiving unit 355. The display unit 36 and the function keypad 37 is also electrically connected to the micro-processing unit 302. The battery 352 supplies power needed for the compact mobile phone device.

To use the compact mobile phone device, the user just needs to hang the hook-shaped earpiece 33 thereof on one ear. When there is an incoming call, the user may talk with the caller directly. When the user wants to make a call, he or she may push keys on the functional key 37 to enter a desired phone number and execute the dial function. After the call is answered, the user may talk with the receiver directly over the compact mobile phone device.

Although the present invention has been described with reference to the preferred embodiments and the best mode of operation thereof, it is apparent to those skilled in the art that a variety of modifications and changes may be made without departing from the scope of the present invention which is intended to be defined by the appended claims.

What is claimed is:

1. A compact mobile phone device, comprising:
a dial control module adapted to attach to a user's waist and comprising:
a first micro-processing unit;
a function keypad electrically connected to said first micro-processing unit for entering a phone number and executing a mobile phone communicating function; and
a radio transmission module electrically connected to said first micro-processing unit for transmitting digital signals and control signals entered via said function keypad and sent to said first micro-processing unit; and
a voice module for wearing on the user's one ear and comprising:
a second micro-processing unit;
a high-frequency signal processing circuit electrically connected to said second micro-processing unit for establishing a communication link with a vicinal base station included in a mobile communication network available for said compact mobile phone;
a voice processing circuit electrically connected to said second micro-processing unit for communicating with a remote user over said communication link established via said high-frequency signal processing circuit;
a sounding unit electrically connected to said voice processing circuit for outputting a vocal signal to the user's ear wearing said voice module;
a voice-receiving unit electrically connected to said voice-processing circuit for receiving a vocal signal emitted by the user; and
a radio receiver module including a radio signal receiver for receiving said digital signals and said other control signals transmitted from said radio transmission module of said dial control module.

2. The compact mobile phone device as claimed in claim 1, wherein said dial control module further comprises a display unit electrically connected to said first micro-processing unit for displaying an operational status of said dial control module.

3. The compact mobile phone device as claimed in claim 1, wherein said dial control module further comprises an attaching means for attaching said dial control module to the user's waist.

4. The compact mobile phone device as claimed in claim 1, wherein said voice module comprises a hook-shaped earpiece for locating said voice 5 module at the user's one ear.

5. The compact mobile phone device as claimed in claim 1, wherein said voice module further comprises an extension bar mounted on the voice module, so that the extension bar is located closely in front of the user's mouth when the user wears said voice module on one ear.

6. The compact mobile phone device as claimed in claim 1, wherein said radio transmission module in said dial control module and said radio receiver module in said voice module communicate with each other through infrared or radio frequency signal transmission.

7. A compact mobile phone device, comprising:
a casing, provided with a hook-shaped earpiece for locating said casing at a user's ear;
a micro-processing unit;
a high-frequency signal processing circuit electrically connected to said micro-processing unit for establishing a communication link with a vicinal base station included in a mobile communication network available for said compact mobile phone;
a voice processing circuit electrically connected to said micro-processing unit for communicating with a remote user over said communication link established via said high-frequency signal processing circuit;
a sounding unit electrically connected to said voice processing circuit for outputting a vocal signal; and
a voice-receiving unit electrically connected to said voice-processing circuit for receiving a vocal signal.

8. The compact mobile phone device as claimed in claim 7, further comprising a display unit electrically connected to said micro-processing unit for displaying an operational status of said compact mobile phone device.

9. The compact mobile phone device as claimed in claim 7, further comprising a function keypad electrically connected to said micro-processing unit for entering at least one phone number.

10. The compact mobile phone device as claimed in claim 7, further comprising an extension bar extended from the casing.
